(19) United States
(12) Patent Application Publication
(10) Pub. No.: US 2022/0196920 A1
(43) Pub. Date: Jun. 23, 2022

(54) DELATCHING DEVICES FOR FIBER OPTIC CONNECTORS

(71) Applicant: CommScope Technologies LLC, Hickory, NC (US)

(72) Inventors: Richard Korczak, Channahon, IL (US); Yousong Wang, Taizhou (CN)

(21) Appl. No.: 17/539,493

(22) Filed: Dec. 1, 2021

Related U.S. Application Data
(60) Provisional application No. 63/129,095, filed on Dec. 22, 2020.
(60) Provisional application No. 63/136,235, filed on Jan. 12, 2021.

(51) Int. Cl. G02B 6/38

(52) U.S. Cl. CPC G02B 6/3825; G02B 6/387; G02B 6/3893

(57) ABSTRACT

The present disclosure describes a delatching device for fiber optic connector assemblies. The delatching device may include a first section having one or more locking mechanisms, and a second identical section configured to mate together with the first section via corresponding locking mechanisms, wherein, when mated together, the first and second sections form an internal cavity having a generally tubular shape that is sized to fit around a fiber optic connector assembly, and wherein the opposing ends of the mated sections have a first inner diameter and the center of the mated sections have a second smaller inner diameter.

### RELATED APPLICATION(S)

The present application claims priority to and the benefit of U.S. Provisional Patent Application Ser. No. 63/129,095, filed Dec. 22, 2020, and U.S. Provisional Patent Application Ser. No. 63/136,235, filed Jan. 12, 2021, the disclosures of which are hereby incorporated herein in full.

### FIELD

The present invention relates generally to electrical cable connectors, and more particularly to devices for disconnecting a fiber optic connector from a telecommunications radio.

### BACKGROUND

Currently, in some telecommunications radios, a small form-factor pluggable (SFP) card that receives a fiber optic connector is located deep within the radio. This location of the SFP card can make it difficult for a technician to reach the latch of a corresponding fiber optic connector (e.g., an LC connector) when the technician needs to disconnect the connector from the card. It may be desirable to have a device that allows the technician to easily reach and disengage the latch of the connector from the SFP card without disturbing the functionality of the connector.

### SUMMARY

A first aspect of the present invention is directed to a delatching device. The delatching device includes a first section having one or more locking mechanisms, and a second identical section configured to mate together with the first section via corresponding locking mechanisms, wherein, when mated together, the first and second sections form an internal cavity having a generally tubular shape and sized to fit around a fiber optic connector assembly, and wherein opposing ends of the mated sections have a first inner diameter and the center of the mated sections have a second smaller inner diameter.

Another aspect of the present invention is directed to a delatching device. The delatching device includes a first section having one or more locking mechanisms, and a second identical section configured to mate together with the first section via corresponding locking mechanisms, wherein, when mated together, the first and section sections form an internal cavity having a generally tubular shape and sized to fit around a fiber optic connector assembly, and wherein one end of the mated sections has a first inner diameter and the opposing end of the mated sections has a second smaller inner diameter.

Another aspect of the present invention is directed to a delatching device. The delatching device includes a main body having three walls that define an internal cavity, and an arm coupled to a top wall of the main body via an extension section, the arm extending outwardly from the extension section and parallel to the top wall, wherein at least a portion of the arm extends outwardly past an end of the main body, and wherein the internal cavity of the main body is sized and configured to fit onto a fiber optic connector assembly.

Another aspect of the present invention is directed to a delatching device. The delatching device includes a main body having three walls that define an internal cavity, wherein one of the walls comprises a slot, a slide member having a slide rail along a bottom surface of the slide member, the slide rail configured to be received and slide within in the slot, a spring configured to bias the slide rail within the slot, and a pin configured to hold the slide rail within the slot, wherein the internal cavity of the main body is sized and configured to fit onto a fiber optic connector assembly.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a perspective view of a fiber optic connector assembly.

FIG. 1B is a schematic section view of the fiber optic connector assembly of FIG. 1A.

FIG. 2A is perspective view of a delatching device according to embodiments of the present invention.

FIG. 2B is a perspective view of a section of the delatching device of FIG. 2A.

FIG. 3A is a side view of a fiber optic connector assembly in combination with the delatching device of FIG. 2A according to embodiments of the present invention.

FIG. 3B is a cross-sectional view of the connector assembly of FIG. 3A taken along line 3B-3B.

FIG. 3C is an exploded view of the connector assembly of FIG. 3A.

FIG. 3D is a side cross-sectional view of the connector assembly of FIG. 3A.

FIG. 3E is a perspective view of the connector assembly of FIG. 3A.

FIG. 3F illustrates use of the delatching device as part of the connector assembly of FIG. 3A.

FIG. 4A is a perspective view of a section of an alternative delatching device according to embodiments of the present invention.

FIG. 4B is a side view of a fiber optic connector assembly in combination with the delatching device of FIG. 4A according to embodiments of the present invention.

FIG. 4C is a perspective of the connector assembly of FIG. 4B.

FIG. 5 is a perspective view of an alternative delatching device according to embodiments of the present invention.

FIGS. 6A-6C illustrate installation and use of the delatching device of FIG. 5 on a fiber optic connector assembly.

FIG. 7 is an exploded view of an alternative delatching device according to embodiments of the present invention.

FIG. 8A is a perspective exploded view of the delatching device of FIG. 7 in relation to a fiber optic connector assembly.

FIGS. 8B and 8C illustrate use of the delatching device of FIG. 7 on a fiber optic connector assembly.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

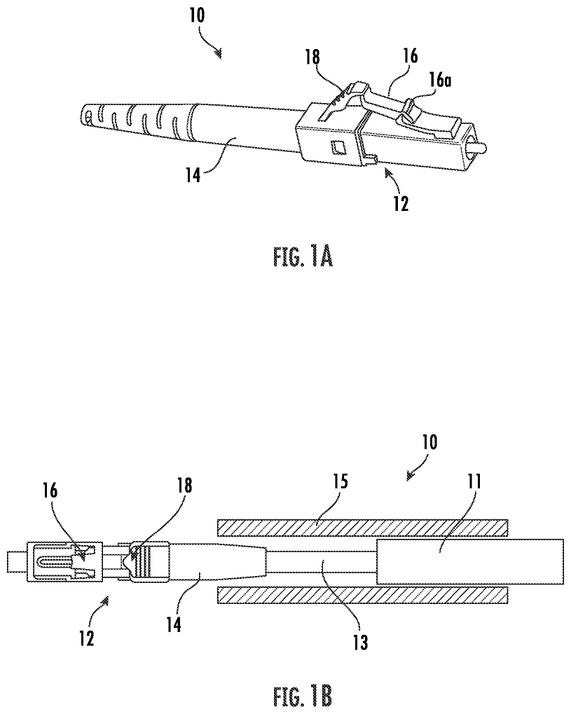

An exemplary fiber optic connector assembly 20 is illustrated in FIGS. 1A-1B. As shown in FIGS. 1A-1B, the connector assembly 20 may include a fiber optic cable 11, a furcation cord 13, an overmold sleeve 14, and a connector 12. In some embodiments, the assembly 20 may also include a heat shrink layer 15. These components will be well-known to those of ordinary skill in the art and need not be described in detail herein.

The connector end 12 of the assembly 20 may include a first latch 16 and a second latch 18 coupled to the first latch 16. The first latch 16 is configured to engage and secure the connector 12 to a telecommunications radio (not shown) (i.e., secure the connector 12 to a mating connector (e.g., an SFP card) within the radio). For example, the latch 16 may comprise one or more protrusions 16a configured to engage a groove, notch, or the like (not shown) located on an inner surface of the mating connector. The connector end 12 may be made of a polymeric material that allows the latch 16 to flex radially inwardly as the connector end 12 is inserted into the mating connector until the protrusion 16a on the latch 16 is received by or engages the groove in the mating connector. Once engaged, the latch 16 exerts radial pressure outwardly on the mating connector, thereby securing the connector 12 to the mating connector.

To release the connector assembly 20 from the mating connector, a technician presses downwardly on the second latch 18 which simultaneously presses downwardly on the first latch 16. This action causes the protrusion(s) 16a of the first latch 16 to disengage from the groove in the mating connector, thereby allowing the connector 12 to be removed from the telecommunications radio. In some telecommunications radios, the mating connector (e.g., SFP card) may be in a location that is difficult for a technician reach with their hand to press down on the latch 18 to remove the connector 12 from the telecommunications radio.

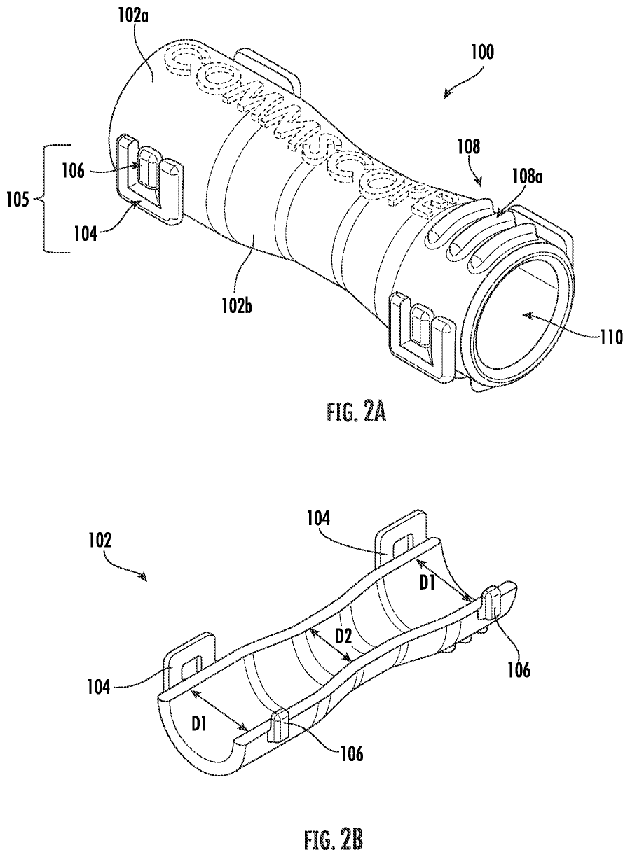

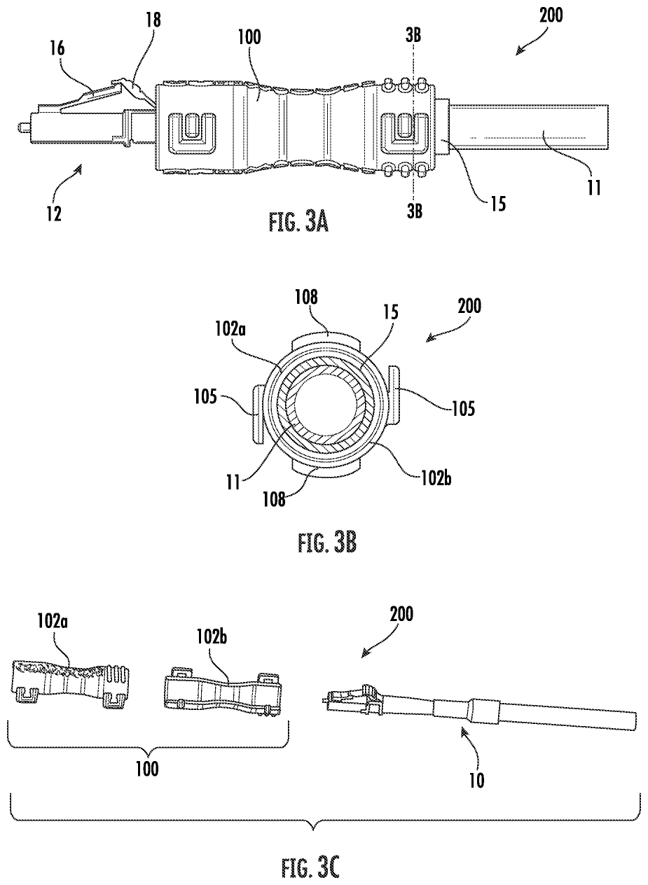

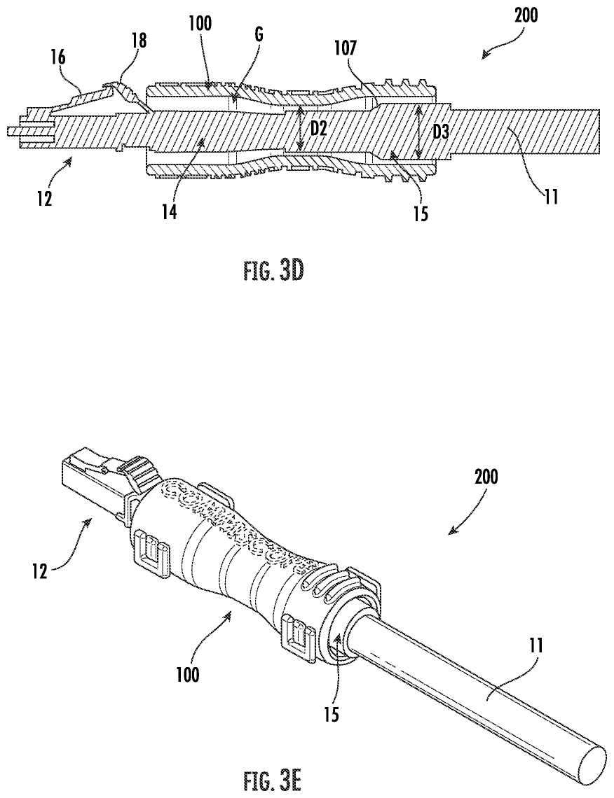

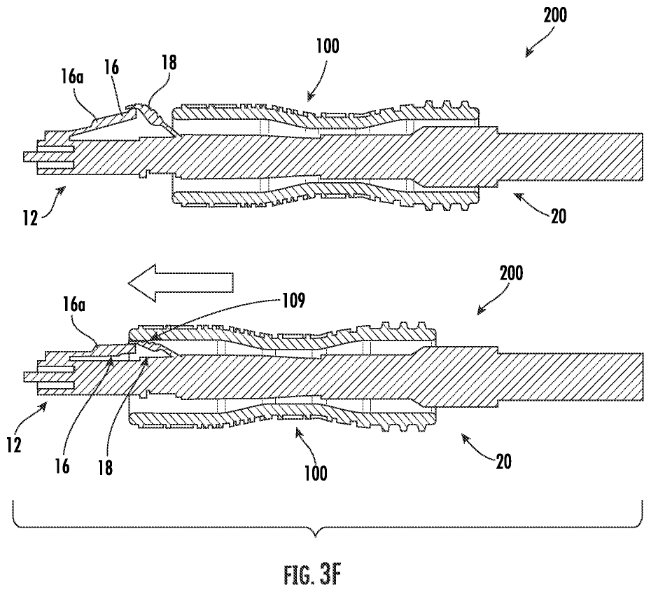

Referring now to FIGS. 2A-3F, a delatching device according to embodiments of the present invention, designated broadly at 100, is illustrated. As shown in FIGS. 2A-2B, the delatching device 100 is styled as a sleeve and comprises two identical sections (or halves) 102a, 102b. The sections 102a, 102b are configured to mate together around a fiber optic connector assembly 20. For example, in some embodiments, the sections 102a, 102b have an arcuate profile that, when mated together, form an internal cavity 110 that is sized and configured to fit around the fiber optic connector assembly 20 (see, e.g., FIGS. 3A-3F).

Each section 102a, 102b has corresponding locking mechanisms 105. The locking mechanisms 105 are configured to secure the two sections 102a, 102b of the device 100 together onto the connector assembly 20. In some embodiments, each locking mechanism 105 may comprise a projection 106 and corresponding snap-clip 104. In some embodiments, each section 102 may comprise two snap-clips 104 and two projections 106. As shown in FIG. 2B, the two snap-clips 104 may be located one side of a section 102 and the two projections 106 may be located on the opposing side of the section 102 (and across from a corresponding snap-clip 104).

As shown in FIG. 2A, when the two sections 102a, 102b of the delatching device 100 are secured together, each snap-clip 104 of one section 102a will engage with a respective projection 106 of the mating section 102b (see also, e.g., FIG. 3C and FIG. 3E). In some embodiments, the delatching device 100 may be formed of a polymeric material, for example, polycarbonate. The polymeric material provides the sections 102a, 102b of the device 100 with a certain degree of flexibility which allows engagement of the snap-clip 104 over the corresponding projection 106 of each locking mechanism 105 to secure the two sections 102a, 102b together. Other similar known locking mechanisms may be used.

In some embodiments, each section 102a, 102b may further comprise a gripping feature 108 adjacent to one end. In some embodiments, the gripping feature 108 may comprise a plurality of protrusions 108a that extend radially outwardly from the outer surface of each section 102a, 102b. The gripping feature 108 provides a location for a technician to grip the delatching device 100 to disengage the connector latch 16 from the mating connector. The gripping feature 108 also provides tactile feel to the delatching device 100, thereby allowing the technician to use the delatching device 100 without having to see the delatching device 100.

As shown in FIGS. 2A-2B, FIGS. 3A-3B, and FIGS. 3D-3F, when the two sections 102a, 102b are mated together, the delatching device 100 may have a generally tubular shape. In some embodiments, the inner diameter D2 near the center of each section 102a, 102b is smaller than the inner diameter D1 at the ends of each section 102a, 102b. The difference in the inner diameters D1, D2 provides a mechanical stop which helps prevent the delatching device 100 from sliding down the cable 11 when the delatching device 100 is installed on the fiber optic connector assembly 20. As shown in FIG. 3D, the inner diameter D1 of the delatching device 100 must be sufficient to fit around the outer diameter D3 of the heat shrink layer 15, outer diameter of the cable 11, or shroud that may be part of the connector assembly 20. However, the inner diameter D2 in the general center of the delatching device 100 is smaller than the outer diameter D3 of the heat shrink layer 15 (or outer diameter of the cable 11 or shroud). The difference in diameters D2, D3 creates a shoulder 107 that helps prevent the delatching device 100 from sliding down the cable 11.

Referring now to FIGS. 3A-3F, a connector assembly 200 according to embodiments of the present invention is shown when the delatching device 100 of the present invention installed on a fiber optic connector assembly 20. FIG. 3A is a side view of the connector assembly 200. FIG. 3B is a cross-section view of the connector assembly taken along line 3B-3B in FIG. 3A. FIG. 3C is an exploded view of the connector assembly 200. FIG. 3D is a side cross-section view of the connector assembly 200. FIG. 3D is a perspective view of the connector assembly 200. FIG. 3F illustrates how the delatching device 100 of the present invention may be used to disengage a connector 12 from a mating connector.

As shown in FIG. 3F, the delatching device 100 is slid toward the connector end 12 of the fiber optic connector assembly 20 (i.e., in the direction of the arrow). As the delatching device 100 slides over the second latch 18 of the connector 12, the second latch 18 is pressed downwardly, which simultaneously presses downwardly the first latch 16 of the connector 12. This action causes the protrusion(s) 16a of the first latch 16 to disengage from the mating connector (not shown), thereby allowing the connector 12 to be removed from the mating connector. Thus, the delatching device 100 may assist a technician in disconnecting a connector 12 from a mating connector when the mating connector (e.g., SFP card) is located in a difficult to reach location on the telecommunications radio (i.e., deep within the radio).

In some embodiments, the delatching device 100 may have a recess or notch 109 on the inner surface of the device 100 that is configured to engage the top surface of latch 18 when the device 100 is slid over the latch 18. The recess 109 may allow the latch 18 to stay engaged with the delatching device 100 while the technician pulls the connector 12 out of the mating connector.

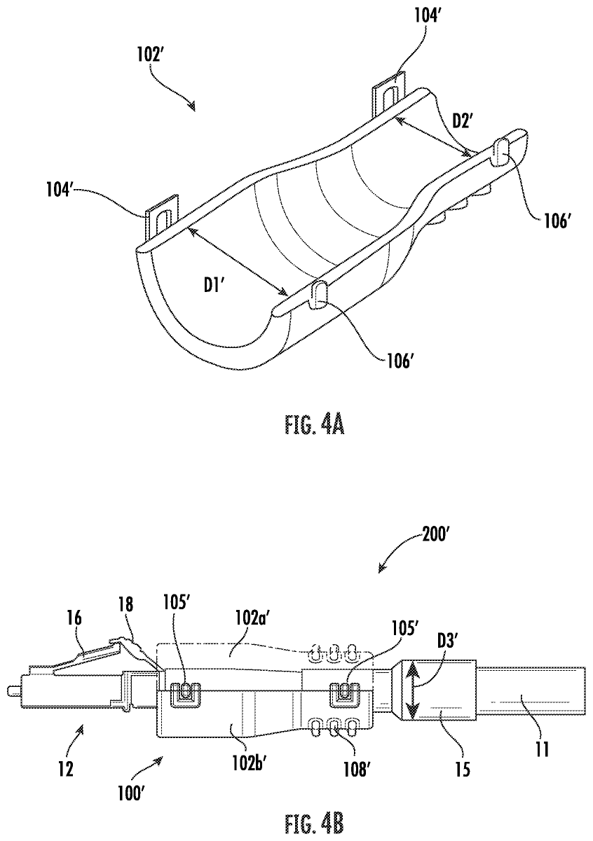

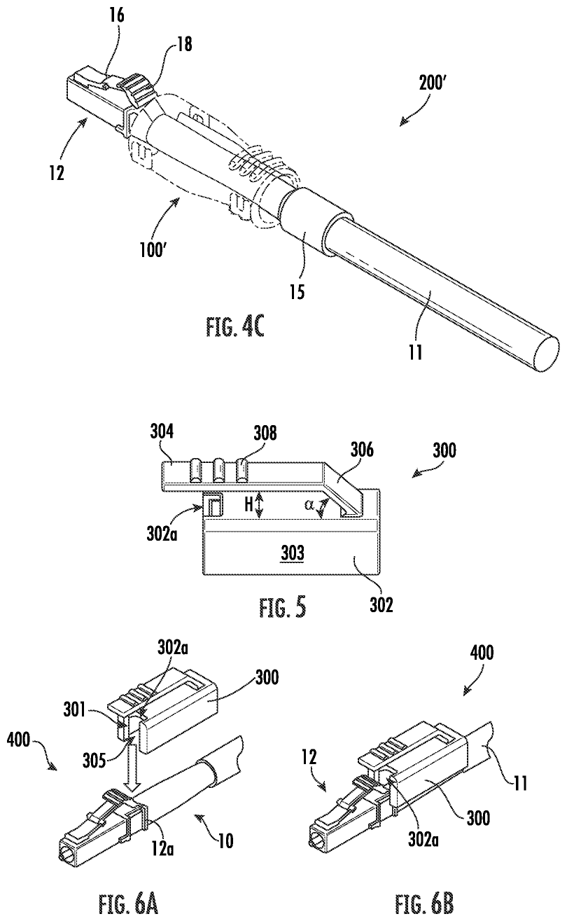

Referring now to FIGS. 4A-4C, an alternative delatching device 100′ according to embodiments of the present invention is illustrated. Properties and/or features of the delatching device 100′ may be as described above in reference to the delatching device 100 shown in FIGS. 2A-3F and duplicate discussion thereof may be omitted herein for the purposes of discussing FIGS. 4A-4C.

As shown in FIG. 4A-4C, similar to the delatching device 100 described herein, the delatching device 100′ is styled as a sleeve and comprises two identical sections (or halves) 102a′, 102b′ that are configured to mate together around a fiber optic connector assembly 20. Each section 102a′, 102b′ also has corresponding locking mechanisms 105′ configured to secure the two sections 102a′, 102b′ of the device 100′ together onto the connector assembly 20. In some embodiments, each locking mechanism 105′ may comprise a projection 106′ and corresponding snap-clip 104′. As shown in FIG. 4B, when the two sections 102a′, 102b′ of the delatching device 100′ are secured together, each snap-clip 104′ of one section 102a′ will engage a respective projection 106′ of the mating section 102b′.

The delatching device 100′ differs from delatching device 100 in that delatching device 100′ is shorter in length than delatching device 100. In addition, as shown in FIG. 4A, one end of the delatching device 100′ (i.e., the end proximate to the connector 12 when secured around the fiber optic connector assembly 20), has a larger inner diameter D1′ than the inner diameter D2′ of the opposing end (i.e., the end proximate to the cable 11). For example, in some embodiments, the delatching device 100′ may have a generally tapered profile. Similar to delatching device 100, the difference in the inner diameters D1′, D2′ provides a mechanical stop and helps prevent the delatching device 100′ from sliding down the cable 11 when the delatching device 100′ is installed on the fiber optic connector assembly 20. As shown in FIGS. 4B-4C, in some embodiments, the smaller inner diameter D2′ is smaller than the outer diameter D3′ of the heat shrink layer 15, thereby preventing the delatching device 100′ from sliding down the cable 11 of the fiber optic connector assembly 20.

The delatching device 100′ functions in a similar manner as the delatching device 100 described herein when installed on a fiber optic connector assembly 20 (e.g., connector assembly 200′). The delatching device 100′ is slid toward the connector end 12 of the fiber optic connector assembly 20 and over the second latch 18 of the connector 12, which pushes downwardly the first latch 16 of the connector 12. This action causes the protrusion(s) 16a of the first latch 16 to disengage from the mating connector, thereby allowing the connector 12 to be removed from the telecommunications radio.

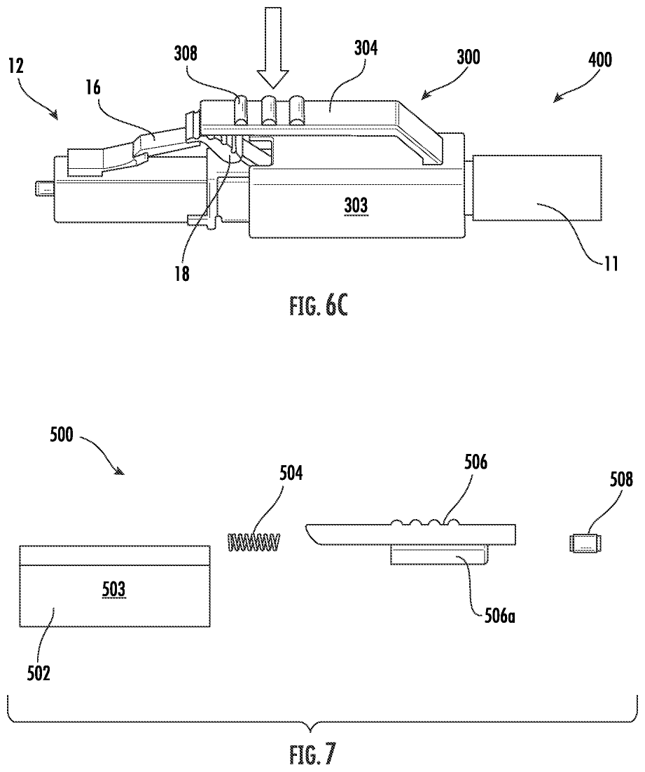

Referring now to FIGS. 5-6C, an alternative delatching device 300 and connector assembly 400 according to embodiments of the present invention are illustrated. As shown in FIG. 5, the delatching device 300 includes a main body 302. The main body 302 may have three walls 303 that define an internal cavity 305 that is sized and configured to fit onto a fiber optic connector assembly 20 (see, e.g., FIGS. 6A-6C). The delatching device 300 also includes an arm 304 coupled to the top wall 303 of the main body 303 via an extension section 306. As shown in FIG. 5, the arm 304 extends outwardly from the extension section 306 and parallel to the top wall 303 of the main body 302 such that at least a portion of the arm 304 extends past an end of the main body 303. As discussed in further detail below, the extension section 306 positions the arm 304 a sufficient height (H) above the top wall 303 such that the arm 304 is able to engage the latch 18 on the connector assembly 20 (see, e.g., FIG. 6C). In some embodiments, the extension section 306 extends outwardly from the top wall 303 of the main body 302 at an angle (α) which allows the arm 304 to have a certain degree of flexibility. In some embodiments, the arm 304 may comprise a gripping feature 308 which serve a similar purpose as the gripping features 108, 108′ described herein.

As shown in FIGS. 6A-6C, the delatching device 300 is configured to slide onto and engage the connector end 12 of a fiber optic connector assembly 20 (e.g., connector assembly 400). In some embodiments, one end of the main body 302 may have a recess 302a that is configured to receive at least a portion of the connector end 12 of the connector assembly 20 (see, e.g., FIG. 5 and FIGS. 6A-6B). In some embodiments, the recess 302a may include a groove 301 that is configured to receive a flanged edge 12a of the connector 12. As shown in FIGS. 6A-6B, when the delatching device 300 is slid onto to the connector end 12 of the assembly 20, the groove 301 and flanged edge 12a may help to secure the delatching device 300 to the assembly 20.

As shown in FIG. 6C, when the delatching device 300 is installed onto the fiber optic connector assembly 20, the arm 304 is a sufficient height (H) above the top wall 303 of the main body 302, and extends outwardly from the main body 302 a sufficient distance to extend over and contact latch 18 of the connector assembly 20. To disconnect the connector 12, a technician presses downwardly on the arm 304 and onto the latch 18 (i.e., in the direction of the arrow in FIG. 6C). Similar to the other delatching devices 100, 100′ described herein, this action causes the protrusion(s) 16a of latch 16 (which is coupled to latch 18) to disengage from the mating connector, thereby allowing the connector 12 to be removed from the telecommunications radio.

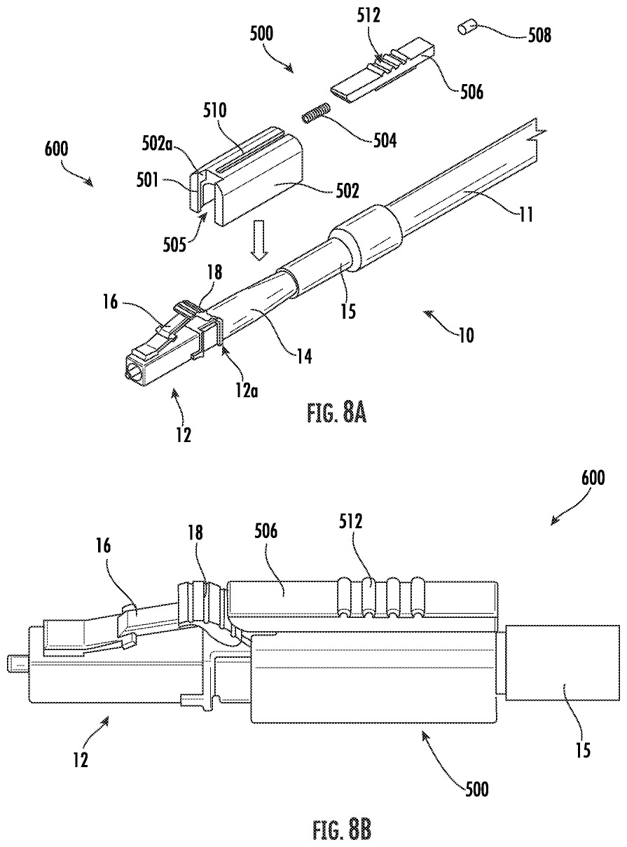

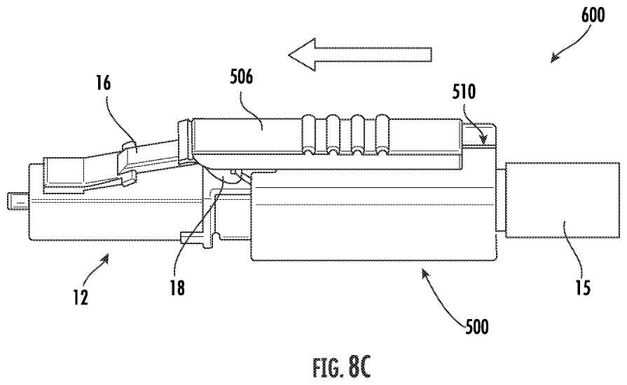

Referring now to FIGS. 7-8C, an alternative delatching device 500 and connector assembly 600 according to embodiments of the present invention is illustrated. Properties and/or features of the delatching device 500 and assembly 600 may be as described above in reference to the delatching device 300 and assembly 400 shown in FIGS. 5-6C and duplicate discussion thereof may be omitted herein for the purposes of discussing FIGS. 7-8C.

As shown in FIG. 7, the delatching device 500 includes a main body 502 and a slide member 506. Similar to delatching device 300, the main body 302 of delatching device 500 may have three walls 503 that define an internal cavity 505 that is sized and configured to fit onto a fiber optic connector assembly 20 (see, e.g., FIGS. 8A-8C). The slide member 506 includes a slide rail 506a along at least a portion of a bottom surface of the slide member 506. In some embodiments, the slide member 506 may include a gripping feature 612 along a top surface of the slide member 506.

As shown in FIG. 8A, the top wall 303 of the main body 302 includes a slot 510. The slot 510 is configured to receive a spring 504, the slide rail 506a, and a pin 508. The spring 504 is configured to bias the slide member 506 (i.e., the slide rail 506a) within the slot 510 and the pin 508 holds the slide member 506 (i.e., the slide rail 506a) within the slot 510.

As shown in FIGS. 8A-8C, the delatching device 500 of the present invention is configured to slide onto and engage the connector end 12 of a fiber optic connector assembly 20 (e.g., connector assembly 600). Similar to delatching device 300 described herein, in some embodiments, one end of the main body 502 of delatching device 500 may have a recess 502a that is configured to receive at least a portion of the connector end 12 of the connector assembly 20 (see, e.g., FIG. 8A). In some embodiments, the recess 502a may include a groove 501 that is configured to receive a flanged edge 12a of the connector 12. As shown in FIGS. 8A-8C, when the delatching device 500 is slid onto to the connector end 12 of the assembly 20, the groove 501 and flanged edge 12a may help to secure the delatching device 500 to the assembly 20.

As shown in FIGS. 8B-8C, when the delatching device 500 is installed onto the fiber optic connector assembly 20, the slide member 506 is configured to engage the latch 18 of the connector assembly 20. To disconnect the connector 12, a technician slides the slide member 506 towards the connector 12 (i.e., in the direction of the arrow in FIG. 8C). The slide rail 506a of the slide member 506 glides within the slot 510 which compresses the spring 504 until the slide member 506 engages the latch 18. Similar to the other delatching devices 100, 100′, 300 described herein, when the slide member 506 of the delatching device 500 engages the latch 18, the latch 18 simultaneously pushes downwardly on latch 16 which causes the protrusion(s) 16a on the latch 16 to disengage from the mating connector, thereby allowing the connector 12 to be removed from the telecommunications radio.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A delatching device, comprising:
a first section having one or more locking mechanisms; and
a second identical section configured to mate together with the first section via corresponding locking mechanisms,
wherein, when mated together, the first and second sections form an internal cavity having a generally tubular shape and sized to fit around a fiber optic connector assembly, and wherein opposing ends of the mated sections have a first inner diameter and the center of the mated sections have a second smaller inner diameter.

2. The delatching device of claim 1, wherein each locking mechanism comprises a projection and a corresponding snap-clip.

3. The delatching device of claim 1, wherein the one or more locking mechanisms of each section comprises two snap-clips on one side of the section and two projections on the opposing side of the section, and when mated together, each snap-clip of the first section will engage a respective projection of the second section to secure the two sections together.

4.-6. (canceled)

7. The delatching device of claim 1, in combination with the fiber optic connector assembly, wherein the delatching device is configured to slide over and engage a latch on the fiber optic connector assembly.

8. A delatching device, comprising:
a first section having one or more locking mechanisms; and
a second identical section configured to mate together with the first section via corresponding locking mechanisms,
wherein, when mated together, the first and section sections form an internal cavity having a generally tubular shape and sized to fit around a fiber optic connector assembly, and wherein one end of the mated sections has a first inner diameter and the opposing end of the mated sections has a second smaller inner diameter.

9. The delatching device of claim 8, wherein each locking mechanism comprises a projection and a corresponding snap-clip.

10. The delatching device of claim 8, wherein the one or more locking mechanisms of each section comprises two snap-clips on one side of the section and two projections on the opposing side of the section, and when mated together, each snap-clip of the first section will engage a respective projection of the second section to secure the two sections together.

11.-13. (canceled)

14. The delatching device of claim 8, in combination with the fiber optic connector assembly, wherein the delatching device is configured to slide over and engage a latch on the fiber optic connector assembly.

15. A method for disconnecting a fiber optic connector assembly, comprising:
providing a fiber optic connector assembly including a connector end having a first latch and a second latch coupled to the first latch, wherein the first latch is engaged with a mating connector of a telecommunications radio;
providing a delatching device of claim 1;
securing the first section to the second section of the delatching device around the fiber optic connector assembly via corresponding locking mechanisms;
sliding the delatching device toward the connector end of the fiber optic connector assembly slides over the second latch, thereby disengaging the first latch from the mating connector;
removing the connector end of the fiber optic connector assembly from the mating connector.

16. A delatching device, comprising:
a main body having three walls that define an internal cavity; and
an arm coupled to a top wall of the main body via an extension section, the arm extending outwardly from the extension section and parallel to the top wall, wherein at least a portion of the arm extends outwardly past an end of the main body, and
wherein the internal cavity of the main body is sized and configured to fit onto a fiber optic connector assembly.

17.-18. (cancelled)

19. The delatching device of claim 16, wherein one end of the main body comprises a recess configured to receive at least a portion of a connector end of the connector assembly.

20. The delatching device of claim 19, wherein the recess comprises a groove that is configured to receive a flanged edge of the connector end.

21. The delatching device of claim 16, in combination with the fiber optic connector assembly, wherein the arm of the delatching device is configured to engage a latch on the fiber optic connector assembly.

22. The delatching device of claim 21, wherein the arm is positioned a sufficient height above the top wall of the main body and extends outwardly from the main body a sufficient distance to extend over and contact the latch of the fiber optic connector assembly.

23. A method for disconnecting a fiber optic connector assembly, comprising:
providing a fiber optic connector assembly including a connector end having a first latch and a second latch coupled to the first latch, wherein the first latch is engaged with a mating connector of a telecommunications radio;
providing a delatching device of claim 16;
sliding the delatching device onto the fiber optic connector assembly such that the arm of the delatching device extends over the second latch of the connector assembly;
pressing downwardly on the arm of the delatching device onto the second latch, thereby disengaging the first latch from the mating connector;
removing the connector end of the fiber optic connector assembly from the mating connector.

24. A delatching device, comprising:
a main body having three walls that define an internal cavity, wherein one of the walls comprises a slot;
a slide member having a slide rail along a bottom surface of the slide member, the slide rail configured to be received and slide within the slot;
a spring configured to bias the slide rail within the slot; and
a pin configured to hold the slide rail within the slot,
wherein the internal cavity of the main body is sized and configured to fit onto a fiber optic connector assembly.

25. (canceled)

26. The delatching device of claim 24, wherein one end of the main body comprises a recess configured to receive at least a portion of a connector end of the connector assembly.

27. The delatching device of claim 26, wherein the recess comprises a groove that is configured to receive a flanged edge of the connector end.

28. The delatching device of claim 24, in combination with a fiber optic connector assembly, wherein the slide rail is configured to slide within the slot of the main body until the slide member engages a latch of the fiber optic connector assembly.

29. A method for disconnecting a fiber optic connector assembly, comprising:
providing a fiber optic connector assembly including a connector end having a first latch and a second latch coupled to the first latch, wherein the first latch is engaged with a mating connector of a telecommunications radio;
providing a delatching device of claim 24;
sliding the delatching device onto the fiber optic connector assembly;
sliding the slide member of delatching device toward the connector end of the connector assembly until the slide member engages second latch which simultaneously pushes downwardly on the first latch, thereby disengaging the first latch from the mating connector;
removing the connector end of the fiber optic connector assembly from the mating connector.
